(19) United States
(12) Patent Application Publication
(10) Pub. No.: US 2007/0278331 A1
(43) Pub. Date: Dec. 6, 2007

(54) Spray Nozzle

(76) Inventor: Birger Hansson, Akarp (SE)

Correspondence Address: MERCHANT & GOULD PC, P.O. BOX 2903, MINNEAPOLIS, MN, 55402-0903, US

(21) Appl. No.: 10/560,406

(22) PCT Filed: Jun. 8, 2004
(86) PCT No.: PCT/SE04/00890

§ 371 Date: Feb. 5, 2007

(30) Foreign Application Priority Data
Jun. 30, 2003 (SE) 0301920-5

(51) Int. Cl. B05B 1/00

(52) U.S. Cl. 239/597

(57) ABSTRACT

A spray nozzle for spraying fountain solution or the like on a roll in a printing machine is presented, wherein the spray nozzle comprises a spray opening at a base plateau at a front end of the spray nozzle. The spray opening opens on a protrusion protruding from the base plateau in the spray direction of the nozzle.

### FIELD OF THE INVENTION

The invention relates to a spray nozzle for spraying fountain solution or the like on a roll in a printing machine. The spray nozzle comprises a spray opening on a front end of the spray nozzle, and a base plateau situated on a level between the front end and an opposite rear end of the spray nozzle.

### PRIOR ART

Spray nozzles for spraying fountain solution on a roll in a printing machine are known e.g. from U.S. Pat. No. 5,595,116.

It is a well-known fact that such spray nozzles tend to get clogged due to impurities in the air in the vicinity of the printing machine. The impurities tend to build up close to the nozzle opening. In order to minimize the problem with nozzle clogging, several different air caps have been used to protect the nozzle from negative influences of impurities in the air. Such an air cap has an opening for the spray, through which low-pressure air is directed, in the same direction as the spray, which gives the spray nozzle a clean environment to work in.

One problem with air caps is that it is difficult to retrofit existing spray systems with air-capped nozzles.

During operation of prior art nozzles, it has been found that the impurities start to build up on sloping sides, in the vicinity of the spray opening. As operation continues, the size of the clogged area increases, and gets closer and closer towards the spray opening. Finally, the spray from the spray opening is adversely affected.

One theory regarding the impurity build up is that a recirculation zone is created in the vicinity of the spray opening. Due to this recirculation, dirt in the ambient air is transported from the air towards the sloping sides. As the dirt carrying recirculating flow from the ambient air hits the sloping sides, the dirt starts to build up.

One option to reduce the clogging of the nozzle is hence to make design changes of the nozzle in the vicinity of the spray opening, in order to change the recirculating flow. Such design changes are beneficial in that it is very easy to retrofit existing spray systems with redesigned nozzles.

### SUMMARY OF THE INVENTION

The invention solves or reduces the above mentioned clogging and other problems by means of a spray nozzle according to claim 1. Preferred embodiments of the invention are described in the dependent claims.

### BRIEF DESCRIPTION OF THE DRAWINGS

In the following, the invention will be described by means of an embodiment, with reference to the appended drawings, wherein

FIG. 1 is a top plan view of a flat-spray nozzle according to the present invention;

FIG. 2 is a section view of the flat spray nozzle, taken along the line B-B of FIG. 1; and

FIG. 3 is a section view of the flat spray nozzle, taken along the line A-A of FIG. 1.

### DESCRIPTION OF AN EMBODIMENT

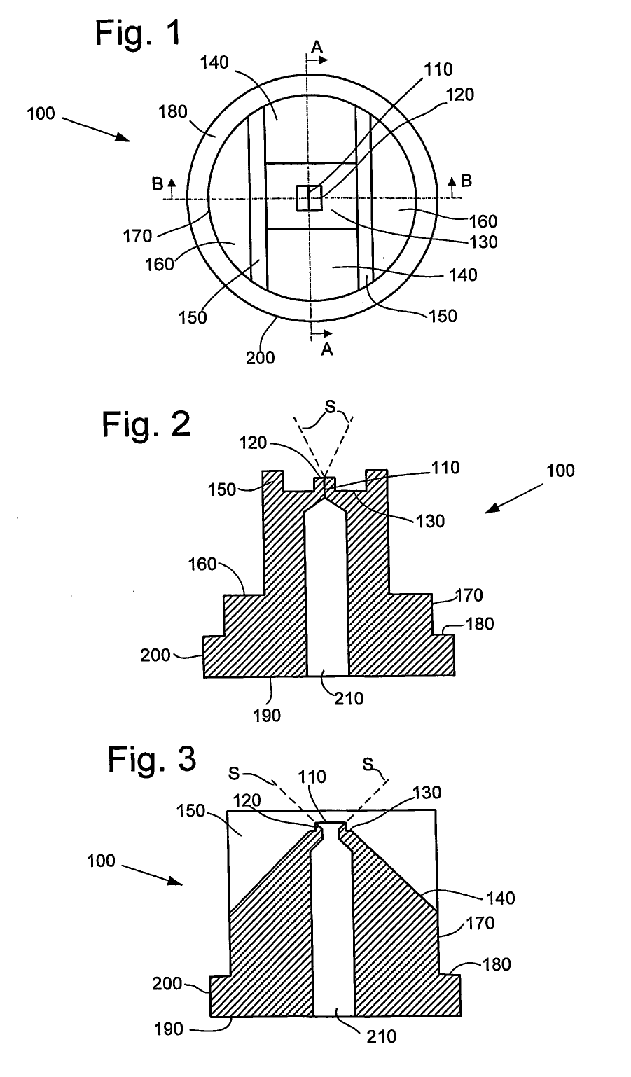

FIGS. 1, 2, and 3 show three different views of a spray nozzle 100 comprising a spray opening 110 that opens on an elevated protrusion 120. In the following, the end of the nozzle comprising the spray opening will be referred to as “front end”, while the opposite end thereof will be referred to as “rear end”. The elevated protrusion 120 protrudes from a base plateau 130, which connects to sloping sides 140. All the above-mentioned components are situated within enclosing walls 150. The enclosing walls 150 connect to surfaces 160, which in turn connect to a circumferential guiding wall 170. Further, a holding surface 180 is provided in the vicinity of the circumferential guiding wall 170, close to the rear end of the nozzle 100. The rear end also comprises a sealing surface 190. The sealing surface 190 and the holding surface 180 are connected by a second circumferential guiding surface 200. Finally, the nozzle 100 comprises a channel 210 that connects the rear end of the nozzle with the spray opening 110.

During operation, a liquid to be sprayed is supplied to the rear end of the channel 210, whereupon the liquid is transported to the spray opening 110 and sprayed through spray opening 110, which gives a flat spray cone as shown by the dashed lines S of FIGS. 2 and 3.

In the following, the function of the spray nozzle 100 will be described.

The nozzle 100 is attached to a nozzle holder (not shown) by means of a threaded nut (not shown) with a shoulder engaging the holding surface 180. During the attachment of the nozzle 100 on the nozzle holder, the nozzle 100 is guided to the right position on the holder by means of the circumferential guiding surfaces 170 and 200. The sealing surface 190 provides a seal between the nozzle holder and the nozzle. To improve the sealing, a gasket or O-ring can be provided between the sealing surface 190 and the nozzle holder. In other embodiments, the seal between the nozzle holder and the nozzle can be provided in other ways, e.g. by means of a protrusion from the holder, which protrusion protrudes into the channel 210. The connection between the channel and the protrusion from the holder is preferably sealed by means of an O-ring.

The function of the enclosing walls 150 is two-folded; on one hand, they enclose the spray opening 110, and serve as a director for the airflow in the vicinity of the spray; on the other hand, they can serve as guides for an air cap.

The sloping sides 140 guide the airflow in the vicinity of the spray opening. On prior art devices, the sloping sides 140 reach all the way up to the spray opening 110, which means the elevated platform 120 and the base plateau 130 actually are the same surface. In other embodiments, it might be advantageous not to have any sloping sides at all, but let the base plateau go all the way out to the guiding surface 170.

The major difference between the prior art nozzles and the nozzle 100 according to the present invention is that the spray opening 110 opens on a protrusion 120, that protrudes over the base plateau 130. The height of the protrusion is, in one embodiment, about 2 mm, but can vary within large limits without departing from the scope of the invention. In one preferred embodiment, the front area of the protrusion is about 2 by 2 mm, i.e. about the length of the oblong spray opening. In the preferred embodiment, the base plateau is about 5 by 5 mm, i.e. the distance between the inner sides of the enclosing walls 150 is 5 mm. The thickness of the enclosing walls is about 1.5 mm, i.e. the distance between the outer sides of the enclosing walls 150 is 8 mm. The sloping sides 140 connect to the guiding surface 170 at a distance of 5 mm from the rear end of the nozzle 100, and has a slope relative to a length axis of the nozzle of about 45 degrees. The diameter of the guiding surface 170 is, in a preferred embodiment, about 12 mm.

The total height of the nozzle 100 is about 10 mm, and the diameter of the guiding surface 200 is about 15 mm.

Finally, the width of the spray opening is about 0.2 mm, and its length is, as mentioned, 2 mm. The dimension of the channel 210 is not important, as long as it is wide enough not to restrict the flow of liquid to be sprayed on its way from the nozzle holder to the spray opening 110.

Preferably, the nozzle is manufactured from stainless steel, but also other materials resistant to a misty environment could be used, e.g. tungsten, plastics, titanium, aluminum, nickel, or the like.

The dimensions above are given for the sole purpose of describing a preferred embodiment, and are not limiting the scope of the invention. The scope of the invention is defined in the appended claims.

1. A spray nozzle for spraying fountain solution or the like on a roll in a printing machine, the spray nozzle comprising a spray opening at a base plateau 3 at a front end of the spray nozzle, comprising the spray opening opens on a protrusion protruding from the base plateau in the spray direction of the nozzle.

2. The spray nozzle according to claim 1, wherein the spray opening is oblong, and hence gives a flat spray.

3. The spray nozzle according to claim 1, wherein sloping sides connect slope rearwardly from the base plateau.

4. The spray nozzle according to claim 1, wherein the protrusion protrudes about 2 mm over the base plateau.

5. The spray nozzle according to claim 1, wherein the protrusion has a front area of about 2 by 2 mm.

6. The spray nozzle according to claim 1, wherein the sloping sides, the spray opening, the base plateau an the protrusion are enclosed by enclosing walls.

7. The spray nozzle according to claim 1, wherein the sloping sides slope with an angle of about 45 degrees.

8. The spray nozzle according to claim 1, wherein the nozzle is manufactured from a uniform piece of material.

9. The spray nozzle according to claim 1, wherein the nozzle is manufactured from stainless steel.
